(19) United States
(12) Patent Application Publication
(10) Pub. No.: US 2023/0289759 A1
(43) Pub. Date: Sep. 14, 2023

(54) METHOD, DEVICE, AND RECORDING MEDIUM

(71) Applicant: Panasonic Intellectual Property Corporation of America, Torrance, CA (US)

(72) Inventors: Junichiro SOEDA, Nara (JP); Junji MICHIYAMA, Fukuoka (JP); Yuji UNAGAMI, Osaka (JP); Naohisa NISHIDA, Osaka (JP); Ayaka MITANI, Osaka (JP); Yuuki HIROSE, Osaka (JP)

(21) Appl. No.: 18/128,383

(22) Filed: Mar. 30, 2023

Related U.S. Application Data
(63) Continuation of application No. PCT/JP2021/035892, filed on Sep. 29, 2021.
(60) Provisional application No. 63/089,150, filed on Oct. 8, 2020.

(51) Int. Cl. G06Q 20/12; G06Q 20/40; A63F 13/792

(52) U.S. Cl. CPC G06Q 20/1235; A63F 13/792; G06Q 20/401

(57) ABSTRACT

A method includes: transmitting, to a second device used by a second user, identification information of a smart contract including a process of providing content according to a provision condition under which a first user allows to provide the content, through short-range wireless communication; receiving transaction data including identification information of the second device and instruction information for instructing to execute the smart contract, through short-range wireless communication; and storing the transaction data received in a distributed ledger and executing the smart contract, to change an owner of the content from the first user to the second user.

### CROSS REFERENCE TO RELATED APPLICATIONS

This is a continuation application of PCT International Application No. PCT/JP2021/035892 filed on Sep. 29, 2021, designating the United States of America, which is based on and claims priority of U.S. Provisional Pat. Application No. 63/089150 filed on Oct. 8, 2020. The entire disclosures of the above-identified applications, including the specifications, drawings and claims are incorporated herein by reference in their entirety.

### FIELD

The present disclosure relates to a method, a device, and a recording medium.

### BACKGROUND

Technology of providing content (specifically, exchanging game characters) using short-range wireless communication (also referred to as StreetPass communication) between terminals moving with users has been disclosed (see PTL 1).

### CITATION LIST

### Patent Literature

PTL 1: Japanese Unexamined Patent Application Publication No. 2012-139362

### SUMMARY

### Technical Problem

There is, however, a problem in that it is difficult to reflect, in content provision, a provision condition under which a user allows to provide content.

In view of this, the present disclosure provides a method whereby content can be provided based on StreetPass communication while reflecting a provision condition under which a user allows to provide the content.

### Solution to Problem

A method according to an aspect of the present disclosure is a method including: transmitting, to a second device used by a second user, identification information of a smart contract including a process of providing content according to a provision condition under which a first user allows to provide the content, through short-range wireless communication; receiving transaction data including identification information of the second device and instruction information for instructing to execute the smart contract, through short-range wireless communication; and storing the transaction data received in a distributed ledger and executing the smart contract, to change an owner of the content from the first user to the second user.

These general and specific aspects may be implemented using a system, a device, an integrated circuit, a computer program, or a computer-readable recording medium such as CD-ROM, or any combination of a system, a device, an integrated circuit, a computer program, and a recording medium.

### Advantageous Effects

With the method according to the present disclosure, content can be provided based on StreetPass communication while reflecting a provision condition under which a user allows to provide the content.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating the structure of a management system in an embodiment.

FIG. 2 is an explanatory diagram schematically illustrating content provision in the management system in the embodiment.

FIG. 3 is a block diagram schematically illustrating the structure of a terminal in the embodiment.

FIG. 4 is a first sequence diagram illustrating processes by the management system in the embodiment.

FIG. 5 is a second sequence diagram illustrating processes by the management system in the embodiment.

FIG. 6 is a flowchart illustrating processes by the terminal in the embodiment.

FIG. 7 is an explanatory diagram illustrating a first example of transaction data in the embodiment.

FIG. 8 is an explanatory diagram illustrating a second example of transaction data in the embodiment.

FIG. 9 is an explanatory diagram illustrating a third example of transaction data in the embodiment.

FIG. 10 is an explanatory diagram illustrating a fourth example of transaction data in the embodiment.

FIG. 11 is an explanatory diagram illustrating a fifth example of transaction data in the embodiment.

FIG. 12 is a flowchart illustrating processes by a terminal in a variation of the embodiment.

FIG. 13 is an explanatory diagram illustrating a first example of transaction data in the variation of the embodiment.

FIG. 14 is an explanatory diagram illustrating a second example of transaction data in the variation of the embodiment.

FIG. 15 is an explanatory diagram illustrating a third example of transaction data in the variation of the embodiment.

FIG. 16 is an explanatory diagram illustrating a fourth example of transaction data in the variation of the embodiment.

FIG. 17 is an explanatory diagram illustrating the data structure of a blockchain.

FIG. 18 is an explanatory diagram illustrating the data structure of transaction data.

### DESCRIPTION OF EMBODIMENT

### Underlying Knowledge Forming Basis of the Present Disclosure

In relation to the content provision technology described in the Background section, the inventors have found the following problem.

Conventionally, there is content provision technology using short-range wireless communication (also referred to as StreetPass communication) between terminals moving with users. In content provision, content prepared beforehand by a provider with the intention of provision is provided.

Technology of setting, when providing content, a condition (also referred to as provision condition) for providing the content is conventionally unknown. For example, the provision condition is used as follows: In the case where the provision condition is met, the provision of the content is permitted. In other words, in the case where the provision condition is not met, the provision of the content is not permitted. Thus, the provision condition is a sufficient condition for transmitting/receiving the content. The provision condition is, for example, a condition defining compensation for the provision of the content.

In other words, content provision technology of providing content only in the case where the compensation which the user obtains as a result of providing the content is more than desired is unknown.

If content can be provided in such a manner, more flexible content provision is possible. This has the advantage of further promoting the distribution of content.

Thus, there is conventionally a problem in that it is difficult to reflect, in content provision, a provision condition under which a user allows to provide content.

In view of this, the present disclosure provides a method whereby, in content provision, a provision condition under which a user allows to provide content can be reflected.

To solve the problem stated above, a method according to an aspect of the present disclosure is a method including: transmitting, to a second device used by a second user, identification information of a smart contract including a process of providing content according to a provision condition under which a first user allows to provide the content, through short-range wireless communication; receiving transaction data including identification information of the second device and instruction information for instructing to execute the smart contract, through short-range wireless communication; and storing the transaction data received in a distributed ledger and executing the smart contract, to change an owner of the content from the first user to the second user.

According to this aspect, the distributed ledger system changes the owner of the content from the first user to the second user according to the provision condition under which the first user allows to provide the content, using short-range wireless communication between the first device and the second device. The use of short-range wireless communication between the first device and the second device enables the provision of the content from the first user to the second user who are located within the distance within which short-range wireless communication is possible. Moreover, since the owner is changed by executing the smart contract reflecting the provision condition under which the first user allows to provide the content, the provision condition under which the first user allows to provide the content can be reflected in the change of the owner (i.e. the provision of the content). Thus, with the method, the content can be provided based on StreetPass communication while reflecting the provision condition under which the user allows to provide the content.

For example, the method may further include: generating a password, and transmitting the password generated to the second device through short-range wireless communication, the transaction data received may be the transaction data transmitted with a password included therein by the second device, and the smart contract may include a process of verifying the password included in the transaction data received against the password transmitted and, when the verifying is successful, providing the content.

According to this aspect, the distributed ledger system verifies the password transmitted from the second device against the password generated by the first device. In the case where the second device is determined to have transmitted the information based on the information received from the first device, the owner of the content is changed from the first user to the second user. This prevents an unauthorized device spoofing the second device from being provided with the content from the first device. Thus, with the method, the content can be provided based on StreetPass communication more appropriately while reflecting the provision condition under which the user allows to provide the content.

For example, the smart contract may include a process of prohibiting execution of the smart contract a second time.

According to this aspect, the distributed ledger system can avoid unauthorized change of the owner of the content. For example, in the case of changing the owner of the content based on password verification, the password is included in the transaction data and stored in the distributed ledger, and thus can be referenced. In such a case, an unauthorized device can use the password to succeed in password verification. With the method, however, such password verification success can be avoided. Hence, with the method, the content can be provided based on StreetPass communication more appropriately while reflecting the provision condition under which the user allows to provide the content.

For example, the provision condition for the content may include value information relating to compensation for provision of the content.

According to this aspect, the provision condition includes the condition of the compensation for the provision of the content under which the first user allows to provide the content. Thus, with the method, the content can be provided based on StreetPass communication while further reflecting the condition of the compensation under which the user allows to provide the content.

For example, the distributed ledger may further manage transfer of value information between users, and the smart contract may include a process of: (a) determining whether the second user has value information equivalent to the compensation for the provision of the content; and (b) providing the content and transferring the value information from the second user to the first user when the second user is determined to have the value information.

According to this aspect, the distributed ledger system can manage the provision of the compensation from the second user to the first user in addition to the provision of the content from the first user to the second user. Thus, with the method, the provision of the content and the provision of the corresponding compensation can be performed based on StreetPass communication while reflecting the provision condition under which the user allows to provide the content.

For example, the content may be a virtual object in a game.

According to this aspect, the distributed ledger system can provide the virtual object based on StreetPass communication while reflecting the provision condition under which the user allows to provide the content.

For example, the value information may be virtual currency.

According to this aspect, the distributed ledger system can perform the provision of the content and the provision of the virtual currency as the corresponding compensation based on StreetPass communication while reflecting the provision condition under which the user allows to provide the content.

A device according to an aspect of the present disclosure is a device including: a processor; and memory connected to the processor, wherein the processor, using the memory: transmits, to a second device used by a second user, identification information of a smart contract including a process of providing content according to a provision condition under which a first user allows to provide the content, through short-range wireless communication; receives transaction data including identification information of the second device and instruction information for instructing to execute the smart contract, through short-range wireless communication; and stores the transaction data received in a distributed ledger and executes the smart contract, to change an owner of the content from the first user to the second user.

According to this aspect, the same effects as the foregoing method can be achieved.

A recording medium according to an aspect of the present disclosure is a non-transitory computer-readable recording medium having recorded thereon a program for causing a computer to execute the foregoing method.

According to this aspect, the same effects as the foregoing method can be achieved.

These general and specific aspects may be implemented using a system, a device, an integrated circuit, a computer program, or a computer-readable recording medium such as CD-ROM, or any combination of a system, a device, an integrated circuit, a computer program, and a recording medium.

Hereinafter, certain exemplary embodiments will be described in greater detail with reference to the accompanying drawings.

Each of the exemplary embodiments described below shows a general or specific example. The numerical values, shapes, materials, elements, the arrangement and connection of the elements, steps, the processing order of the steps etc. shown in the following exemplary embodiments are mere examples, and therefore do not limit the scope of the appended claims and their equivalents. Therefore, among the elements in the following exemplary embodiments, those not recited in any one of the independent claims are described as optional elements.

### Embodiment

This embodiment describes a method (also referred to as a control method) whereby content can be provided based on StreetPass communication while reflecting a provision condition under which a user allows to provide the content.

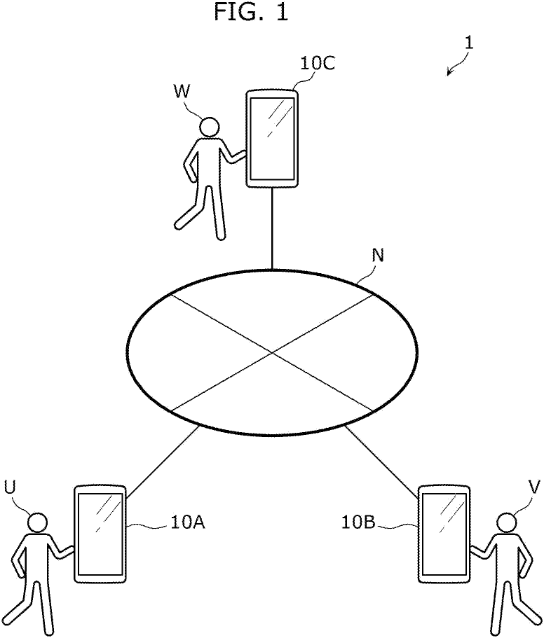

FIG. 1 is a block diagram schematically illustrating the structure of management system 1 in this embodiment.

As illustrated in FIG. 1, management system 1 includes terminals 10A, 10B, and 10C (also referred to as terminals 10A, etc.). Terminals 10A, etc. are each connected to network N, and can communicate with each other through network N.

Management system 1 is a distributed ledger system including the plurality of terminals 10A, etc. that are a plurality of devices each having a distributed ledger. The distributed ledger manages the owner of content. The transaction data stored in the distributed ledger includes information indicating the owner of the content. An example of the content is a virtual object in a game (more specifically, a character in a game). The content is not limited as long as it is electronic content, and may be software, text, image, music, or the like. The content may be information that is linked to a physical object and indicates the ownership of the physical object. The content itself may be managed in the distributed ledger, managed in a storage (not illustrated) in the terminal of the owner of the content, or managed in a server (not illustrated). The content can be managed as a non-fungible token (NFT).

The distributed ledger can also manage the transfer of value information. In such a case, the transaction data stored in the distributed ledger includes information indicating the transfer of value information. The value information can be managed as a fungible token (FT). An example of the value information is virtual currency (also referred to as coins). An example of the value information is legal currency.

In the case where the content is a virtual object in a game and the value information is virtual currency, management system 1 can be regarded as a system that manages transactions of the virtual object in the game with the virtual currency as compensation.

Terminal 10A is one of the plurality of terminals 10A, etc. each having the distributed ledger in management system 1. The distributed ledger in terminal 10A stores transaction data. Terminals 10A, etc. can perform content provision and compensation provision by storing transaction data in the distributed ledger and executing a smart contract. The user of terminal 10A is also referred to as user U.

Terminals 10B and 10C are each a device having the same functions as terminal 10A, and each operate independently of terminal 10A. The user of terminal 10B is also referred to as user V, and the user of terminal 10C is also referred to as user W.

Each of terminals 10A, etc. is a node included in a distributed ledger network. In the distributed ledger network, each of terminals 10A, etc. is uniquely identified by an address. Each smart contract executed by terminals 10A, etc. is also uniquely identified by an address in the distributed ledger network.

When terminals 10A, 10B, and 10C and smart contract A transmit/receive information in the distributed ledger network, the respective addresses of terminals 10A, 10B, and 10C and the address of smart contract A are used.

Although this embodiment describes an example in which management system 1 includes three terminals 10A, etc., management system 1 may include more terminals.

Network N may be any communication line or network. Examples include the Internet, a mobile phone carrier network, an Internet provider access network, and a public access network.

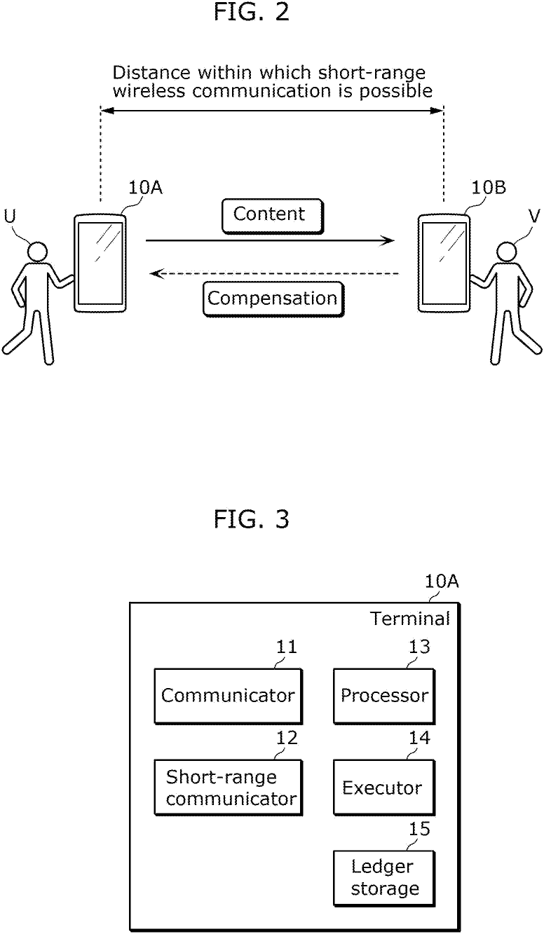

FIG. 2 is an explanatory diagram schematically illustrating content provision in management system 1 in this embodiment.

An instance in which user U intends to provide content and user V intends to be provided with the content will be described below.

User U is moving with terminal 10A. User V is moving with terminal 10B.

If terminals 10A and 10B are located within a distance within which short-range wireless communication is possible when terminals 10A and 10B are carried by respective users U and V and moving, terminals 10A and 10B transmit and receive information relating to the provision of the content through short-range wireless communication. Consequently, the content is provided from user U to user V. Here, the compensation for the provision of the content may be provided from user V to user U.

The content is provided by storing, in the distributed ledger managing the owner of the content, transaction data for changing the owner of the content. In addition, the content itself may be provided from user U to user V. In the case where the content is managed in the terminal of user U, the content itself is provided from the terminal of user U to the terminal of user V. The compensation for the content is provided by storing, in the distributed ledger managing the transfer of value information, transaction data indicating the transfer of the value information.

An example in which content is provided from user U to user V based on short-range wireless communication performed by terminals 10A and 10B as illustrated in FIG. 2 will be described below.

Terminal 10A is also referred to as a first device, and terminal 10B is also referred to as a second device. User U is also referred to as a first user, and user V is also referred to as a second user.

First, the functions of terminal 10A will be described in more detail below.

FIG. 3 is a block diagram schematically illustrating the structure of terminal 10A in this embodiment.

As illustrated in FIG. 3, terminal 10A includes communicator 11, short-range communicator 12, processor 13, executor 14, and ledger storage 15.

Communicator 11 is a communication interface communicably connected to network N. Communicator 11 includes a communication interface of a communication standard suitable for connection to network N. Communicator 11 may include a communication circuit for transmitting and receiving communication signals according to the communication standard, and a communication connector or a communication antenna.

Short-range communicator 12 is a communication interface that connects, by wireless communication, to a terminal relatively close physically. Non-limiting examples of the communication standard of wireless communication used by short-range communicator 12 include Bluetooth®, Wi-Fi®, and Infrared Data Association (IrDA®).

Short-range communicator 12 repeatedly transmits a predetermined communication signal (for example, a beacon signal) according to the communication standard to surrounding devices.

In the case where terminals 10A and 10B are located within a distance within which short-range wireless communication is possible, short-range communicator 12, as a result of receiving a predetermined communication signal (for example, a beacon signal) according to the communication standard from terminal 10B, detects that short-range wireless communication between terminals 10A and 10B is possible, and performs short-range wireless communication with terminal 10B.

Processor 13 is a functional unit that executes a content provision process and the like. Processor 13 can be implemented by a processor (for example, central processing unit (CPU)) included in terminal 10A executing a program using memory. Processor 13 also executes a process relating to transaction data and a process relating to smart contracts.

Processor 13 generates a contract code of a smart contract (also referred to as smart contract A) including a process of providing content according to a provision condition under which user U allows to provide the content. Processor 13 causes the generated contract code to be stored in the distributed ledger of each of terminals 10A, etc. The provision condition for the content may include value information relating to the compensation for the provision of the content.

When short-range wireless communication between terminals 10A and 10B is possible, processor 13 transmits identification information of smart contract A (specifically, contract address of smart contract A) to terminal 10B through short-range wireless communication. Having received the identification information, terminal 10B, in the case of intending to be provided with the content, transmits transaction data (also referred to as transaction data B) including identification information of terminal 10B and instruction information for instructing to execute smart contract A. Processor 13 receives transaction data B.

Processor 13 receives transaction data B transmitted from terminal 10B. Processor 13 stores received transaction data B in the distributed ledger and executes smart contract A, to execute the process of providing the content.

When storing transaction data in the distributed ledger, processor 13 stores the transaction data in the distributed ledger in the form corresponding to the type of the distributed ledger. Processor 13 also transmits/receives communication data with processor 13 included in each of the other terminals from among terminals 10A, etc. via communicator 11, and causes the transaction data to be stored in ledger storage 15 in each of the other terminals. For example, in the case where the distributed ledger is a blockchain, processor 13 generates a block including new transaction data, forms a consensus among terminals 10A, etc. for the generated block by a consensus algorithm, and then stores the block in ledger storage 15.

Executor 14 is a functional unit that executes smart contracts. Executor 14 can be implemented by a processor (for example, central processing unit (CPU)) included in terminal 10A executing a program using memory.

Specifically, in response to processor 13 storing the transaction data including the instruction information for instructing to execute smart contract A in the distributed ledger, executor 14 reads the contract code of smart contract A from ledger storage 15 and executes smart contract A. Executor 14 changes the owner of the content from user U to user V by executing smart contract A.

Ledger storage 15 is a storage storing the distributed ledger. The distributed ledger stored in ledger storage 15 stores one or more items of transaction data, and is managed using a feature such as hash values to make tampering difficult (described later). Ledger storage 15 stores the transaction data provided from processor 13 in the distributed ledger. The distributed ledger stores the transaction data from the past to the present. The transaction data is managed so as not to be tampered with, based on the feature that tampering with information recorded in the distributed ledger is difficult.

The distributed ledger is, for example, a blockchain. Although this example is used in this embodiment, the distributed ledger may be in any other form (for example, IOTA or hash graph). The distributed ledger may or may not execute a consensus algorithm (for example, Practical Byzantine Fault Tolerance (PBFT), Proof of Work (PoW), or Proof of Stake (PoS)) when storing new data. An example of a distributed ledger technology that does not execute a consensus algorithm is Hyperledger Fabric.

Next, the functions of terminal 10B will be described in more detail below.

Terminal 10B includes communicator 11, short-range communicator 12, processor 13, executor 14, and ledger storage 15, as in terminal 10A.

Of the structural elements included in terminal 10B, the structural elements other than processor 13 are the same as those in terminal 10A.

Processor 13 is a functional unit that executes a content provision process and the like. Processor 13 can be implemented by a processor (for example, CPU) included in terminal 10B executing a program using memory. Processor 13 also executes a process relating to transaction data and a process relating to smart contracts.

Processor 13 receives the identification information of smart contract A transmitted from processor 13 in terminal 10A, through short-range wireless communication. Processor 13 obtains the provision condition for the content indicated by smart contract A based on the received identification information, and determines whether to be provided with the content according to the obtained provision condition. The determination may be made by user V, or made by processor 13 based on information set beforehand. The obtained provision condition may be displayed on a display of the terminal of user V. User V inputs whether to be provided with the content, by performing operation corresponding to whether to agree to the provision condition displayed on the display.

In the case where processor 13 determines to be provided with the content, processor 13 transmits transaction data B including the identification information of terminal 10B and instruction information for instructing to execute smart contract A.

Although the functions of terminal 10A and the functions of terminal 10B are separately described above, terminals 10A and 10B may each be a terminal having both the functions of terminal 10A and the functions of terminal 10B described above.

In management system 1, terminal 10A may perform the content provision process after verifying (i.e. making sure) that terminal 10B has transmitted the information based on the information received from terminal 10A. A password may be used for the verification. In this case, processor 13 in terminal 10A includes, in smart contract A, a conditional formula used for the password verification. For example, the conditional formula to be satisfied by the password may be expressed as f(a) = P, where a is the password, and f(a) is a function with a as a variable, such as a hash function.

Processor 13 in terminal 10A generates a password beforehand, and substitutes the generated password into function f(a) to calculate P. Processor 13 in terminal 10A includes function f(a) and calculated P in smart contract A, and stores smart contract A in the distributed ledger.

When short-range wireless communication between terminals 10A and 10B is possible, processor 13 in terminal 10A transmits the password generated beforehand to terminal 10B through short-range wireless communication. Terminal 10B transmits transaction data B including the received password to terminal 10A. In this case, smart contract A may include a process of verifying the password included in received transaction data B against the password transmitted from processor 13 in terminal 10A and, in the case where the verification is successful, providing the content.

Smart contract A may also include a process of prohibiting the execution of smart contract A the second time. For example, this process can be performed using a variable (for example, a flag variable) indicating whether the execution of smart contract A is permitted. Specifically, the variable is initially set to a value (for example, 0) indicating that the execution of smart contract A is permitted. Then, the prohibition can be achieved by a process, in smart contract A, of changing the variable to a value (for example, 1) indicating that the execution is not permitted (i.e. the execution is prohibited).

The reason for prohibiting the execution of smart contract A the second time is to prevent success of unauthorized password verification. Once the transaction data including the password has been stored in the distributed ledger, all terminals 10A, etc. and all users can reference the password, and therefore any terminal or user referencing the password can succeed in the password verification. Hence, in management system 1, smart contract A is permitted to be executed only once, and the password is permitted to be used only once. The password is thus also called a one-time password.

In the case where the distributed ledger included in management system 1 manages the transfer of value information between the respective users of the plurality of terminals 10A, etc., smart contract A may also include a process of: (a) determining whether user V has value information equivalent to the compensation for the provision of the content; and (b) providing the content and transferring the value information from user V to user U in the case where user V is determined to have the value information.

In the case where a party that intends to provide the content is not the owner of the content or in the case where, despite compensation being needed in order to be provided with the content, a party that intends to be provided with the content does not have value information equivalent to the compensation, the party may be penalized. The penalization can be performed by storing transaction data for penalization in the distributed ledger.

In the case where a process of providing content, a process of transferring value information, or a process of penalization has been performed, terminal 10A or terminal 10B may be controlled to notify user U or user V that the process has been performed. As an example, terminal 10A or terminal 10B may notify that the process has been performed through display on the display, vibration by its vibration function, sound output by its audio function, or light emission by its light emitting function.

Processes by management system 1 will be described in more detail below.

An example in which a password is used in content provision is used here. Moreover, an example in which corresponding compensation needs to be provided in content provision is used here.

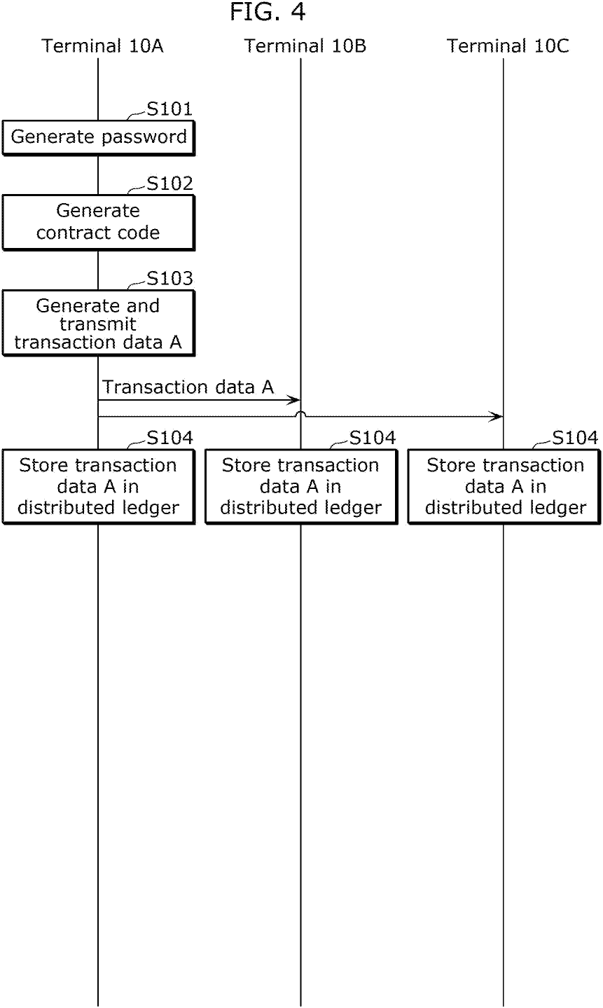

FIG. 4 is a first sequence diagram illustrating processes by management system 1 in this embodiment. FIG. 4 illustrates processes that are executed before terminal 10A performs short-range wireless communication with terminal 10B and that constitute a process (typically referred to as a deployment process) of storing a contract code of smart contract A in the distributed ledger.

In Step S101, terminal 10A generates a password.

In Step S102, terminal 10A generates a contract code of smart contract A.

In Step S103, terminal 10A generates transaction data A including the contract code generated in Step S102, and transmits generated transaction data A to other terminals 10B and 10C. Terminals 10B and 10C receive the transaction data.

In Step S104, terminal 10A stores the transaction data generated in Step S103, in the distributed ledger. Terminals 10B and 10C each store the transaction data received in Step S103, in the distributed ledger. Specifically, terminals 10B and 10C each receive the transaction data from terminal 10A and, in the case where the validity of the received transaction data is successfully verified, record the transaction data in the storage. Thus, terminals 10B and 10C each record only the transaction data the validity of which has been successfully verified in the storage, so that unnecessary consumption of memory can be reduced. Terminals 10A, etc. may store the transaction data in the distributed ledger on the condition that consensus is formed based on a consensus algorithm. The same applies to storing the below-described transaction data (transaction data B to J) in the distributed ledger.

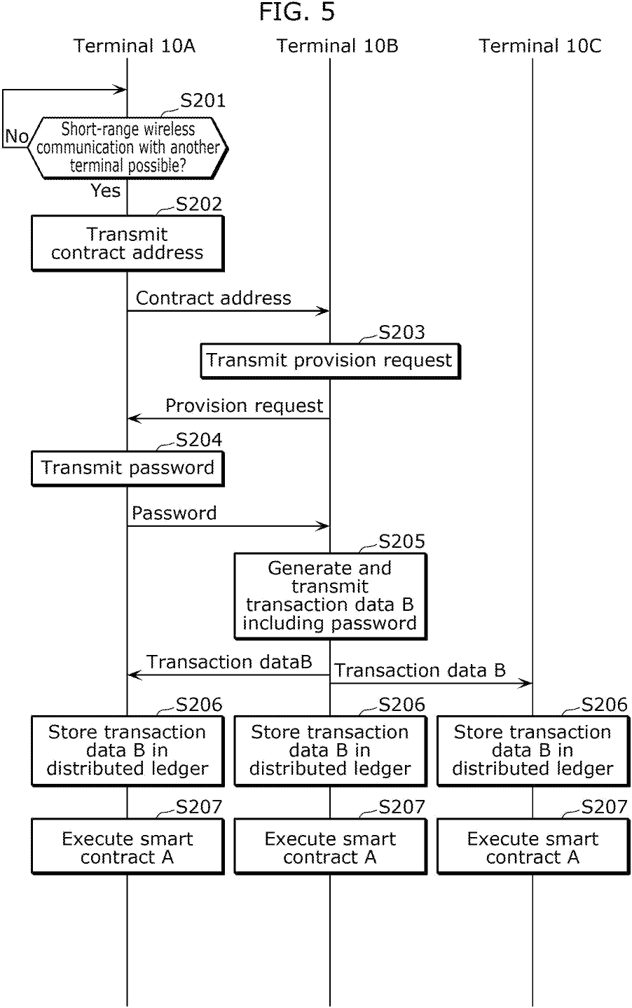

By the series of processes illustrated in FIG. 4, the contract code of smart contract A can be stored in the distributed ledger. FIG. 5 is a second sequence diagram illustrating processes by management system 1 in this embodiment. FIG. 6 is a flowchart illustrating processes by terminal 10A in this embodiment.

FIG. 5 and FIG. 6 relate to the processes in which terminals 10A, etc. execute smart contract A based on short-range wireless communication between terminals 10A and 10B.

In Step S201, terminal 10A determines whether short-range wireless communication with another terminal is possible. In the case where terminal 10A determines that short-range wireless communication with another terminal is possible (Step S201: Yes), terminal 10A advances to Step S202. Otherwise (Step S201: No), terminal 10A performs Step S201 again. That is, terminal 10A waits in Step S201 until short-range wireless communication with another terminal becomes possible.

It is assumed here that, in Step S201, it has become possible for terminal 10A to perform short-range wireless communication with terminal 10B as an example of another terminal.

In Step S202, terminal 10A transmits a contract address of smart contract A to terminal 10B through short-range wireless communication. Terminal 10B receives the transmitted contract address.

In Step S203, in response to receiving the contract address in Step S202, terminal 10B references a provision condition for content indicated by smart contract A using the received contract address. In the case where terminal 10B determines to be provided with the content according to the provision condition, terminal 10B transmits a provision request for the content to terminal 10A. Terminal 10A receives the transmitted provision request.

In Step S204, in response to receiving the provision request in Step S203, terminal 10A transmits the password to terminal 10B. The password transmitted is the password generated in Step S101. Terminal 10B receives the transmitted password.

In Step S205, in response to receiving the password in Step S204, terminal 10B generates transaction data (also referred to as transaction data B) including instruction information for instructing to execute smart contract A and the received password, and transmits transaction data B to other terminals 10A and 10C. Other terminals 10A and 10C receive transmitted transaction data B.

In Step S206, terminal 10B stores transaction data B generated in Step S205, in the distributed ledger. Terminals 10A and 10C each store transaction data B received in Step S205, in the distributed ledger.

In Step S207, in response to storing transaction data B in the distributed ledger in Step S206, executor 14 in each of terminals 10A, etc. executes smart contract A. The processes performed by executing smart contract A will be described in detail below, with reference to FIG. 6.

As illustrated in FIG. 6, in Step S301, executor 14 determines whether the execution of smart contract A is permitted. In the case where executor 14 determines that the execution of smart contract A is permitted (Step S301: Yes), executor 14 advances to Step S302. Otherwise (Step ′S301: No), the series of processes illustrated in FIG. 6 end. When Step S301 is performed for the first time, the execution of smart contract A is permitted (for example, flag variable = 0).

In Step S302, executor 14 performs a verification process on the password included in transaction data B generated in Step S205 against the password transmitted from terminal 10A in Step S204, and determines whether the verification is successful. In the case where executor 14 determines that the verification is successful (Step S302: Yes), executor 14 advances to Step S303. Otherwise (Step S302: No), executor 14 advances to Step S321.

In Step S303, executor 14 determines whether the owner of the content is user U. Specifically, executor 14 references the distributed ledger, and determines whether user U is recorded as the owner of the content in the distributed ledger. In the case where executor 14 determines that the owner of the content is user U (Step S303: Yes), executor 14 advances to Step S304. Otherwise (Step S303: No), executor 14 advances to Step S311.

In Step S304, executor 14 determines whether user V has the coins equivalent to the compensation for the provision of the content. Specifically, executor 14 references the distributed ledger, and determines whether the coins possessed by user V are not less than the coins equivalent to the compensation for the provision of the content. In the case where executor 14 determines that user V has the coins equivalent to the compensation for the provision of the content (Step S304: Yes), executor 14 advances to Step S305. Otherwise (Step S304: No), executor 14 advances to Step S321.

In Step S305, executor 14 generates transaction data (also referred to as transaction data C) for changing the owner of the content from user U to user V, and transmits generated transaction data C to other terminals 10B and 10C. Terminals 10B and 10C receive transmitted transaction data C.

In Step S306, executor 14 stores transaction data C generated in Step S305, in the distributed ledger. Terminals 10B and 10C each store transaction data C received in Step S305, in the distributed ledger.

In Step S307, executor 14 generates transaction data (also referred to as transaction data D) for transferring the coins equivalent to the compensation for the provision of the content from user V to user U, and transmits generated transaction data D to other terminals 10B and 10C. Terminals 10B and 10C receive transmitted transaction data D.

In Step S308, executor 14 stores transaction data D generated in Step S307, in the distributed ledger. Terminals 10B and 10C each store transaction data D received in Step S307, in the distributed ledger.

In Step S309, executor 14 performs control to prevent the execution of smart contract A from being permitted (for example, changes the flag variable to 1). As a result of this control, the execution of smart contract A is not permitted (i.e. the execution of smart contract A is prohibited) from this time onward.

In Step S311, executor 14 generates transaction data (also referred to as transaction data E) for penalizing user U, and transmits generated transaction data E to other terminals 10B and 10C. Terminals 10B and 10C receive transmitted transaction data E.

In Step S312, executor 14 stores transaction data E generated in Step S311, in the distributed ledger. Terminals 10B and 10C each store transaction data E received in Step S311, in the distributed ledger.

In Step S321, executor 14 generates transaction data (also referred to as transaction data F) for penalizing user V, and transmits generated transaction data F to other terminals 10B and 10C. Terminals 10B and 10C receive transmitted transaction data F.

In Step S322, executor 14 stores transaction data F generated in Step S321, in the distributed ledger. Terminals 10B and 10C each store transaction data F received in Step S321, in the distributed ledger.

After Step S309, S312, or S322, the series of processes illustrated in FIG. 6 end.

In the case of not using a password, Step S204 is omitted, and transaction data B generated by terminal 10B in Step S205 does not include a password.

Terminals 10B and 10C execute smart contract A to execute the processes illustrated in FIG. 6, as with terminal 10A.

By the processes illustrated in FIG. 5 and FIG. 6, smart contract A can be executed based on short-range wireless communication between terminals 10A and 10B.

Transaction data used by management system 1 will be described below.

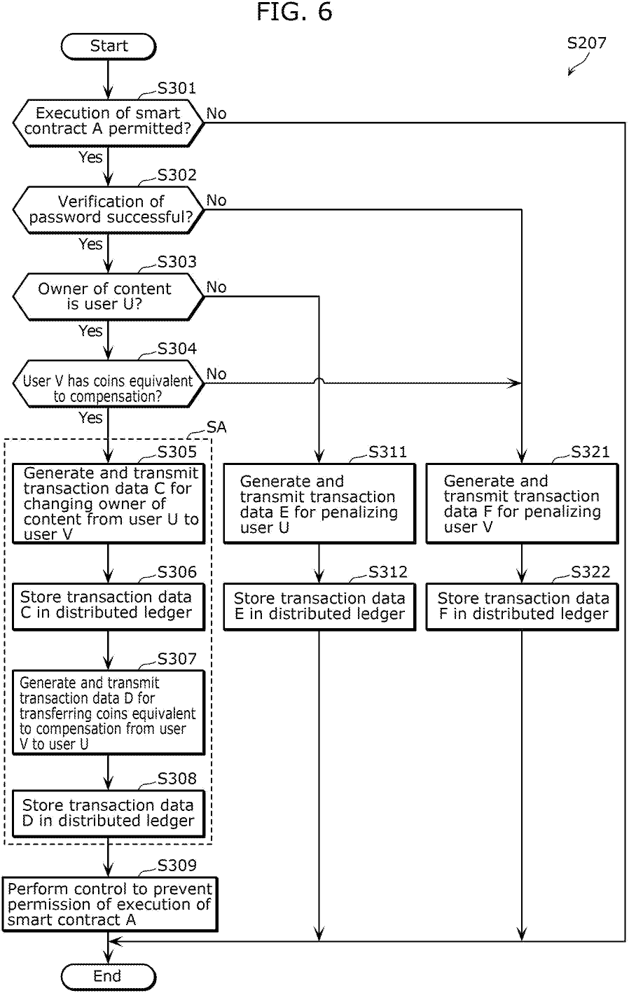

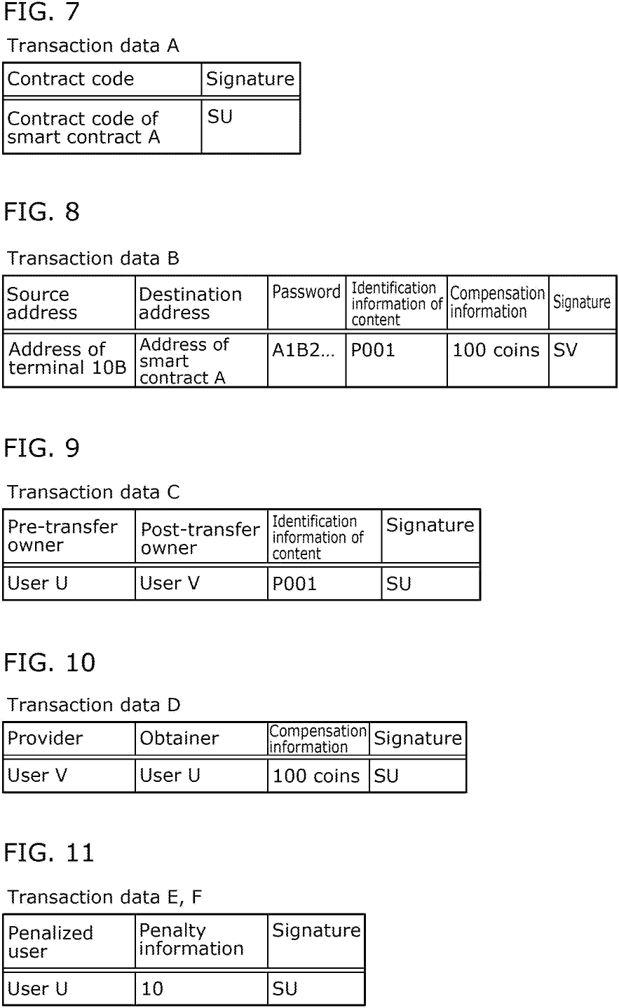

FIG. 7 is an explanatory diagram illustrating transaction data A which is a first example of transaction data in this embodiment. Transaction data A is used in the deployment process for smart contract A (see FIG. 4).

As illustrated in FIG. 7, transaction data A includes a contract code and a signature.

The contract code is the contract code of smart contract A, and at least describes a content provision process. The contract code is written using a language for writing smart contracts (for example, Solidity language or Vyper language).

The signature includes a digital signature (i.e. SU) of user U who is the user of the terminal (i.e. terminal 10A) generating transaction data A.

FIG. 8 is an explanatory diagram illustrating transaction data B which is a second example of transaction data in this embodiment. Transaction data B includes instruction information for instructing to execute smart contract A.

As illustrated in FIG. 8, transaction data B includes a source address, a destination address, a password, identification information of content, compensation information, and a signature.

The source address is the address of the terminal transmitting transaction data B, and specifically includes the address of terminal 10B.

The destination address is the address of the smart contract the execution of which is instructed by transaction data B, and specifically is set to the address of smart contract A. The destination address set to the address of smart contract A corresponds to the instruction information for instructing to execute smart contract A.

The password is the password which terminal 10B has received from terminal 10A (Step S204, S205).

The identification information of content is information for uniquely identifying the content the provision of which is requested by transaction data B.

The compensation information is value information provided as the compensation for the provision of the content when requesting the provision of the content by transaction data B, and is, for example, the coins equivalent to the compensation.

The signature includes a digital signature (i.e. SV) of user V who is the user of the terminal (i.e. terminal 10B) generating transaction data B.

FIG. 9 is an explanatory diagram illustrating transaction data C which is a third example of transaction data in this embodiment. Transaction data C is used as information indicating a change of the owner of the content.

As illustrated in FIG. 9, transaction data C includes a pre-transfer owner, a post-transfer owner, identification information of content, and a signature.

The pre-transfer owner is identification information for uniquely identifying the owner of the content before transfer, and specifically includes the identification information of user U.

The post-transfer owner is identification information for uniquely identifying the owner of the content after transfer, and specifically includes the identification information of user V.

The identification information of content is information for uniquely identifying the content the owner of which is changed by transaction data C.

The signature includes a digital signature (i.e. SU) of user U who is the user of the terminal (i.e. terminal 10A) generating transaction data C.

FIG. 10 is an explanatory diagram illustrating transaction data D which is a fourth example of transaction data in this embodiment. Transaction data D is used as information indicating the provision of compensation.

As illustrated in FIG. 10, transaction data D includes a provider, an obtainer, compensation information, and a signature.

The provider is identification information for uniquely identifying the user who provides the compensation, and specifically includes the identification information of user V.

The obtainer is identification information for uniquely identifying the user who obtains the compensation, and specifically includes the identification information of user U.

The compensation information is information indicating the amount of the compensation for the provision of the content.

The signature includes a digital signature (i.e. SU) of user U who is the user of the terminal (i.e. terminal 10A) generating transaction data D.

FIG. 11 is an explanatory diagram illustrating transaction data E or F which is a fifth example of transaction data in this embodiment. Transaction data E or F is used as information indicating penalization.

As illustrated in FIG. 11, transaction data E or F includes a penalized user, penalty information, and a signature.

The penalized user is identification information for uniquely identifying the user penalized. In transaction data E, the penalized user includes the identification information of user U. In transaction data F, the penalized user includes the identification information of user V.

The penalty information is information indicating the penalty imposed on the penalized user. For example, the penalty information is information numerically indicating the magnitude of the penalty. For example, the penalty information is information of the coins that the penalized user is required to pay. For example, the penalty information is information indicating that the penalized user is blacklisted as a person to beware of.

The signature includes a digital signature (i.e. SU) of user U who is the user of the terminal (i.e. terminal 10A) generating transaction data E or F.

As described above, management system 1 in this embodiment can perform content provision based on StreetPass communication while reflecting a provision condition under which a user allows to provide content.

In this embodiment, terminal 10A which is the device providing the content generates the contract code of smart contract A indicating the provision condition (see Step S102 in FIG. 4). Alternatively, terminal 10B which is the device provided with the content may generate the contract code of the smart contract indicating the provision condition for being provided with the content. In such a case, terminal 10B generates transaction data including the generated contract code, and causes the generated transaction data to be stored in the distributed ledger in each of terminals 10A, etc.

### (Variation of Embodiment)

This variation describes another example of the processes (FIG. 6) which terminal 10A performs by executing smart contract A.

In this variation, the process of changing the owner of the content and the process of transferring the coins equivalent to the compensation (i.e. the processes in dashed line box SA in FIG. 6) in the foregoing embodiment are executed by smart contracts.

FIG. 12 is a flowchart illustrating processes by terminal 10A in this variation. The processes illustrated in FIG. 12 are another example of the processes in dashed line box SA in FIG. 6.

In Step S401, executor 14 generates a contract code of a smart contract (also referred to as smart contract B) for changing the owner of the content from user U to user V.

In Step S402, executor 14 generates transaction data (also referred to as transaction data G) including the contract code of smart contract B generated in Step S401, and transmits generated transaction data G to other terminals 10B and 10C. Terminals 10B and 10C receive transmitted transaction data G.

In Step S403, executor 14 stores transaction data G generated in Step S402, in the distributed ledger. Terminals 10B and 10C each store transaction data G received in Step S402, in the distributed ledger.

Steps S401 to S403 correspond to the deployment process for smart contract B.

In Step S404, executor 14 generates transaction data (also referred to as transaction data H) including instruction information for instructing to execute smart contract B, and transmits generated transaction data H to other terminals 10B and 10C. Terminals 10B and 10C receive transmitted transaction data H.

In Step S405, executor 14 stores transaction data H generated in Step S404, in the distributed ledger. Terminals 10B and 10C each store transaction data H received in Step S404, in the distributed ledger.

In Step S406, in response to storing transaction data H in the distributed ledger in Step S405, executor 14 in each of terminals 10A, etc. executes smart contract B. Since smart contract B describes the process of changing the owner of the content from user U to user V, executor 14 changes the owner of the content from user U to user V by executing smart contract B.

In Step S411, executor 14 generates a contract code of a smart contract (also referred to as smart contract C) for transferring the coins equivalent to the compensation for the provision of the content from user V to user U.

In Step S412, executor 14 generates transaction data (also referred to as transaction data I) including the contract code of smart contract C generated in Step S411, and transmits generated transaction data I to other terminals 10B and 10C. Terminals 10B and 10C receive transmitted transaction data I.

In Step S413, executor 14 stores transaction data I generated in Step S412, in the distributed ledger. Terminals 10B and 10C each store transaction data I received in Step S412, in the distributed ledger.

Steps S411 to S413 correspond to the deployment process for smart contract C.

In Step S414, executor 14 generates transaction data (also referred to as transaction data J) including instruction information for instructing to execute smart contract C, and transmits generated transaction data J to other terminals 10B and 10C. Terminals 10B and 10C receive transmitted transaction data J.

In Step S415, executor 14 stores transaction data J generated in Step S414, in the distributed ledger. Terminals 10B and 10C each store transaction data J received in Step S414, in the distributed ledger.

In Step S416, in response to storing transaction data J in the distributed ledger in Step S415, executor 14 in each of terminals 10A, etc. executes smart contract C. Since smart contract C describes the process of transferring the coins equivalent to the compensation for the provision of the content from user V to user U, executor 14 transfers the coins equivalent to the compensation for the provision of the content from user V to user U by executing smart contract C.

Transaction data used by management system 1 in this variation will be described below.

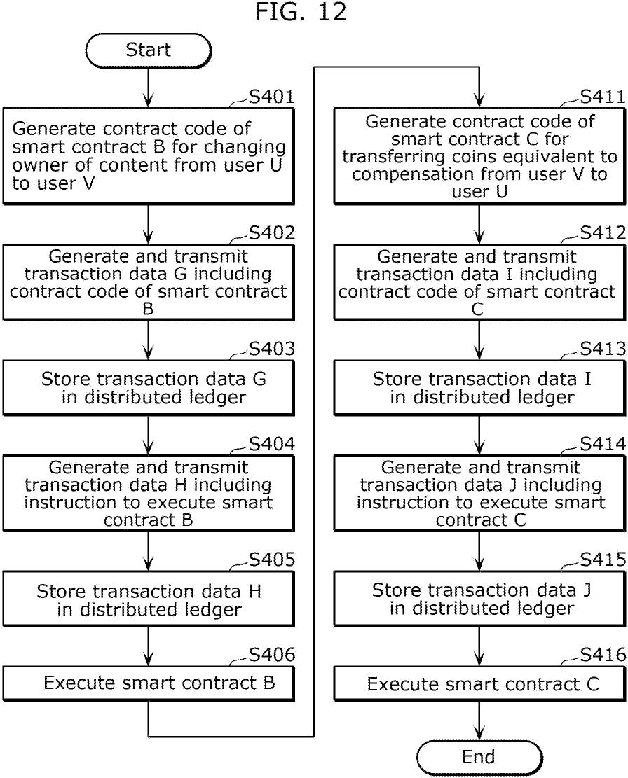

FIG. 13 is an explanatory diagram illustrating transaction data G which is a first example of transaction data in this variation. Transaction data G is used in the deployment process for smart contract B (see Steps S401 to S403 in FIG. 12).

As illustrated in FIG. 13, transaction data G includes a contract code and a signature.

The contract code is the contract code of smart contract B, and at least describes a content provision process. The contract code is written using a language for writing smart contracts (for example, Solidity language or Go language).

The signature includes a digital signature (i.e. SU) of user U who is the user of the terminal (i.e. terminal 10A) generating transaction data G.

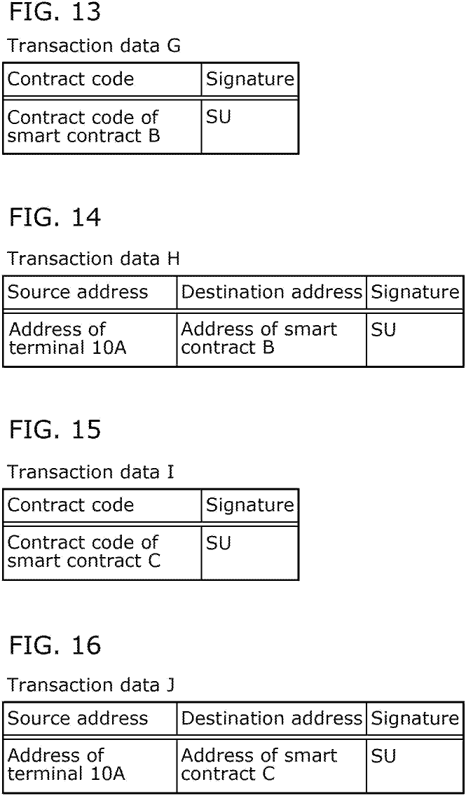

FIG. 14 is an explanatory diagram illustrating transaction data H which is a second example of transaction data in this variation. Transaction data H is used as instruction information for instructing to execute smart contract B.

As illustrated in FIG. 14, transaction data H includes a source address, a destination address, and a signature..

The source address is the address of the terminal transmitting transaction data H, and specifically includes the address of terminal 10A.

The destination address is the address of the smart contract the execution of which is instructed by transaction data H, and specifically includes the address of smart contract B.

The signature includes a digital signature (i.e. SU) of user U who is the user of the terminal (i.e. terminal 10A) generating transaction data H.

FIG. 15 is an explanatory diagram illustrating transaction data I which is a third example of transaction data in this variation. Transaction data I is used in the deployment process for smart contract C (see Steps S411 to S413 in FIG. 12).

As illustrated in FIG. 15, transaction data I includes a contract code and a signature.

The contract code is the contract code of smart contract C, and at least describes a content provision process. The contract code is written using a language for writing smart contracts (for example, Solidity language or Go language).

The signature includes a digital signature (i.e. SU) of user U who is the user of the terminal (i.e. terminal 10A) generating transaction data I.

FIG. 16 is an explanatory diagram illustrating transaction data J which is a fourth example of transaction data in this variation. Transaction data J is used as instruction information for instructing to execute smart contract C.

As illustrated in FIG. 16, transaction data J includes a source address, a destination address, and a signature..

The source address is the address of the terminal transmitting transaction data J, and specifically includes the address of terminal 10A.

The destination address is the address of the smart contract the execution of which is instructed by transaction data J, and specifically includes the address of smart contract C.

The signature includes a digital signature (i.e. SU) of user U who is the user of the terminal (i.e. terminal 10A) generating transaction data J.

### Supplemental Remarks

The distributed ledger in the foregoing embodiment or variation will be described below. While a blockchain is described as an example of the distributed ledger here, the same applies to other distributed ledgers.

FIG. 17 is an explanatory diagram illustrating the data structure of a blockchain.

The blockchain is formed by connecting blocks as recording units in a chain. Each block has a plurality of items of transaction data and a hash value of the immediately previous block. Specifically, block B2 includes a hash value of block B1 preceding block B2. A hash value calculated from a plurality of items of transaction data and the hash value of block B1 included in block B2 is included in block B3 as a hash value of block B2. By connecting blocks in a chain where each block includes information of the previous block as a hash value in this way, tampering with recorded transaction data can be effectively prevented.

If past transaction data is changed, the hash value of the block will end up being different from the value before the change. To disguise the tampered block as proper, all subsequent blocks need to be recreated. Such operation is practically very difficult. This property is used to ensure the difficulty of tampering with blockchains.

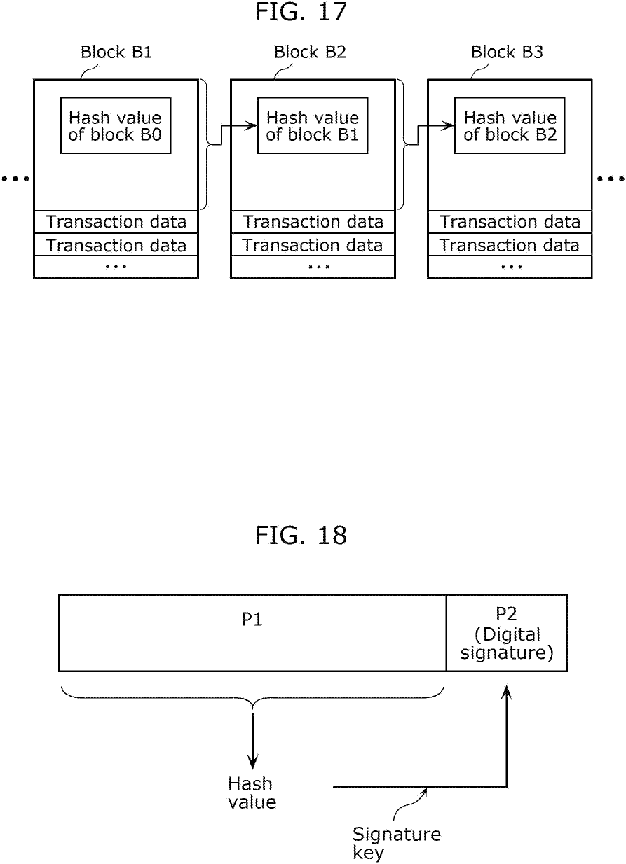

FIG. 18 is an explanatory diagram illustrating the data structure of transaction data.

The transaction data illustrated in FIG. 18 includes transaction body P1 and digital signature P2. Transaction body P1 is a data body included in the transaction data. Digital signature P2 is generated by signing a hash value of transaction body P1 using a signature key of the generator of the transaction data, i.e. by encrypting the hash value using a private key of the generator. As means for digital signatures, the elliptic curve digital signature algorithm (ECDSA), CRYSTALS-Dilithium, FALCON, SPHINCS+, and the like may be used.

Since the transaction data includes digital signature P2, tampering is substantially impossible. Tampering with the transaction body is thus prevented.

Although the foregoing embodiment or variation describes an example in which terminals 10A, etc. have the distributed ledger, a plurality of devices other than terminals 10A, etc. may have the distributed ledger. The plurality of devices other than terminals 10A, etc. are, for example, servers. In this case, transaction data generated by terminals 10A, etc. is transmitted to one of the plurality of devices. In the case where the device successfully verifies the validity of the received transaction data, the device transfers the transaction data to each of the other devices from among the plurality of devices, forms a consensus with the other devices by a consensus algorithm, and then stores the transaction data in the distributed ledger.

As described above, with the method according to the foregoing embodiment or variation, the distributed ledger system changes the owner of the content from the first user to the second user according to the provision condition under which the first user allows to provide the content, using short-range wireless communication between the first device and the second device. The use of short-range wireless communication between the first device and the second device enables the provision of the content from the first user to the second user who are located within the distance within which short-range wireless communication is possible. Moreover, since the owner is changed by executing the smart contract reflecting the provision condition under which the first user allows to provide the content, the provision condition under which the first user allows to provide the content can be reflected in the change of the owner (i.e. the provision of the content). Thus, with the method, the content can be provided based on StreetPass communication while reflecting the provision condition under which the user allows to provide the content.

Moreover, the distributed ledger system verifies the password transmitted from the second device against the password generated by the first device. In the case where the second device is determined to have transmitted the information based on the information received from the first device, the owner of the content is changed from the first user to the second user. This prevents an unauthorized device spoofing the second device from being provided with the content from the first device. Thus, with the method, the content can be provided based on StreetPass communication more appropriately while reflecting the provision condition under which the user allows to provide the content.

Moreover, the distributed ledger system can avoid unauthorized change of the owner of the content. In the case of changing the owner of the content based on password verification, the password is included in the transaction data and stored in the distributed ledger, and thus can be referenced. In such a case, an unauthorized device can use the password to succeed in password verification. With the method, however, such password verification success can be avoided. Hence, with the method, the content can be provided based on StreetPass communication more appropriately while reflecting the provision condition under which the user allows to provide the content.

Moreover, the provision condition includes the condition of the compensation for the provision of the content under which the first user allows to provide the content. Thus, with the method, the content can be provided based on StreetPass communication while further reflecting the condition of the compensation under which the user allows to provide the content.

Moreover, the distributed ledger system can manage the provision of the compensation from the second user to the first user in addition to the provision of the content from the first user to the second user. Thus, with the method, the provision of the content and the provision of the corresponding compensation can be performed based on StreetPass communication while reflecting the provision condition under which the user allows to provide the content.

Moreover, the distributed ledger system can provide the virtual object based on StreetPass communication while reflecting the provision condition under which the user allows to provide the content.

Moreover, the distributed ledger system can perform the provision of the content and the provision of the virtual currency as the corresponding compensation based on StreetPass communication while reflecting the provision condition under which the user allows to provide the content.

Each of the structural elements in the foregoing embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or semiconductor memory. For example, software for realizing the content management system, etc. according to the foregoing embodiment is the following program.

The program causes a computer to execute a method including: transmitting, to a second device used by a second user, identification information of a smart contract including a process of providing content according to a provision condition under which a first user allows to provide the content, through short-range wireless communication; receiving transaction data including identification information of the second device and instruction information for instructing to execute the smart contract, through short-range wireless communication; and storing the transaction data received in a distributed ledger and executing the smart contract, to change an owner of the content from the first user to the second user.

While a method, etc. according to one or more aspects have been described above by way of embodiments, the present disclosure is not limited to such embodiments. Other modifications obtained by applying various changes conceivable by a person skilled in the art to the embodiments and any combinations of the structural elements in different embodiments without departing from the scope of the present disclosure are also included in the scope of one or more aspects.

### Industrial Applicability

The present disclosure can be used for management systems that manage content provision based on StreetPass communication.

1. A method comprising:
transmitting, to a second device used by a second user, identification information of a smart contract including a process of providing content according to a provision condition under which a first user allows to provide the content, through short-range wireless communication;
receiving transaction data including identification information of the second device and instruction information for instructing to execute the smart contract, through short-range wireless communication; and
storing the transaction data received in a distributed ledger and executing the smart contract, to change an owner of the content from the first user to the second user.

2. The method according to claim 1, further comprising:
generating a password, and transmitting the password generated to the second device through short-range wireless communication,
wherein the transaction data received is the transaction data transmitted with a password included therein by the second device, and
the smart contract includes a process of verifying the password included in the transaction data received against the password transmitted and, when the verifying is successful, providing the content.

3. The method according to claim 1,
wherein the smart contract includes a process of prohibiting execution of the smart contract a second time.

4. The method according to claim 1,
wherein the provision condition for the content includes value information relating to compensation for provision of the content.

5. The method according to claim 4,
wherein the distributed ledger further manages transfer of value information between users, and
the smart contract includes a process of:
(a) determining whether the second user has value information equivalent to the compensation for the provision of the content; and
(b) providing the content and transferring the value information from the second user to the first user when the second user is determined to have the value information.

6. The method according to claim 1,
wherein the content is a virtual object in a game.

7. The method according to claim 5,
wherein the value information is virtual currency.

8. A device comprising:
a processor; and
memory connected to the processor,
wherein the processor, using the memory:
transmits, to a second device used by a second user, identification information of a smart contract including a process of providing content according to a provision condition under which a first user allows to provide the content, through short-range wireless communication;
receives transaction data including identification information of the second device and instruction information for instructing to execute the smart contract, through short-range wireless communication; and
stores the transaction data received in a distributed ledger and executes the smart contract, to change an owner of the content from the first user to the second user.

9. A non-transitory computer-readable recording medium having recorded thereon a program for causing a computer to execute the method according to claim 1.
